(19) United States
(12) Patent Application Publication
(10) Pub. No.: US 2009/0132321 A1
(43) Pub. Date: May 21, 2009

(54) MAINTENANCE PLANNING SYSTEM AND MAINTENANCE PLANNING METHOD

(75) Inventors: Yoshikatsu Kamisuwa, Tokyo (JP); Rintaro Nakane, Kanagawa-ken (JP); Hiroyo Katou, Shizuoka-ken (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/268,486

(22) Filed: Nov. 11, 2008

Related U.S. Application Data
(60) Provisional application No. 60/988,339, filed on Nov. 15, 2007.

(30) Foreign Application Priority Data
Jun. 11, 2008 (JP) 2008-151796

(51) Int. Cl. G06Q 10/00

(52) U.S. Cl. 705/8; 705/7

(57) ABSTRACT

A maintenance planning system comprises a counter value acquiring unit to acquire a counter value indicating use results of consumable parts of a plurality of apparatuses that are maintenance targets; an interval information acquiring unit, among information related to a combination of a visit interval to specify a time interval to visit installation places of the plurality of apparatuses that are maintenance targets to perform a maintenance check operation for the plurality of apparatuses that are maintenance targets with a replacement interval specified to replace each consumable part and associated with the visit interval, to acquire a combination of the visit interval and the replacement interval for minimizing a predetermined cost for each consumable part of the plurality of apparatuses that are maintenance targets; a maintenance plan creation unit, on the basis of the minimized visit interval and replacement interval acquired by the interval information acquiring unit and the counter value acquired by the counter value acquiring unit, to identify the apparatus that is a maintenance target to be visited next, timing of next visit, and a consumable part to be replaced at the timing; and a display unit to display information identified by the maintenance plan creation unit on a terminal.

### CROSS-REFERENCE TO RELATED APPLICATION

This application is based upon and claims the benefit of priority from the prior U.S. Patent Application No. 60/988,339, filed on Nov. 15, 2007, and Japanese Patent Application No. 2008-151796, filed on Jun. 11, 2008; the entire contents of all of which are incorporated herein by reference.

### FIELD OF THE INVENTION

The present invention relates to a maintenance planning system and a maintenance planning method for inferring the failure time of an image forming apparatus having a plurality of consumable parts and the deterioration degree of each component and reflecting it on the maintenance plan.

### DESCRIPTION OF THE BACKGROUND

The conventional maintenance plan cannot balance the user's damage risk caused by unavailability of a product with the cost charged for maintenance. To reduce the product failure risk, it is necessary to foresee a component having high possibility of failure and replace it before the failure or replace it before expiration of the life on the basis of the number of use times of the component and use time. Therefore, the component replacement operation must be performed and managed in safety, thus a problem arises that the maintenance cost is increased. On the other hand, if it is intended to use fully the component before expiration of the life to reduce the maintenance cost, when the operation of component replacement is switched to the repair operation due to a component failure, the downtime of the product becomes longer, and a problem arises that the user's damage caused by unavailability of the product is increased.

In U.S. Patent Application Publication No. 2008/0002995, a technique is disclosed that enables reduction in cost related to the maintenance operation and enables reduction in the risk due to the downtime of a product. This technique calculates a combination for optimizing the time interval of visiting the installation place of an apparatus for maintenance check and the time interval of replacement of each consumable part. By the timing of the next visit for the maintenance operation on the basis of the concerned combination and detection of the consumable part to be replaced at the concerned timing, the technique predicts and decides the visit time and replacement part balanced in cost and risk.

U.S. Patent Application Publication No. 2008/0002995 aforementioned discloses reduction in cost related to the maintenance operation of a single product which is a maintenance target and reduction in the downtime (that is, risk) of the product, though it cannot optimize simultaneously the maintenance plans of a plurality of products.

### SUMMARY OF THE INVENTION

The present invention is intended to provide a maintenance planning system and a maintenance planning method for calculating a combination for optimizing the time interval of visiting for maintenance for each product and the time interval of replacement of each consumable part and forming an operation plan, thereby taking the balance between risk and cost into account for a plurality of products.

The maintenance planning system of an embodiment of the present invention is comprised a counter value acquiring unit to acquire a counter value indicating use results of consumable parts of a plurality of apparatuses that are maintenance targets; an interval information acquiring unit, among information related to a combination of a visit interval to specify a time interval to visit installation places of the plurality of apparatuses that are maintenance targets to perform a maintenance check operation for the plurality of apparatuses that are maintenance targets with a replacement interval specified to replace each consumable part and associated with the visit interval, to acquire a combination of the visit interval and the replacement interval for minimizing a predetermined cost for each consumable part of the plurality of apparatuses that are maintenance targets; a maintenance plan creation unit, on the basis of the minimized visit interval and replacement interval acquired by the interval information acquiring unit and the counter value acquired by the counter value acquiring unit, to identify the apparatus that is a maintenance target to be visited next, timing of next visit, and a consumable part to be replaced at the timing; and a display unit to display information identified by the maintenance plan creation unit on a terminal.

Furthermore, the maintenance planning system of an embodiment of the present invention is comprised counter value acquiring means for acquiring a counter value indicating use results of consumable parts of a plurality of apparatuses that are maintenance targets; interval information acquiring means, among information related to a combination of a visit interval for specifying a time interval for visiting installation places of the plurality of apparatuses that are maintenance targets to perform a maintenance check operation for the plurality of apparatuses that are maintenance targets with a replacement interval which is specified to replace each consumable part and is associated with the visit interval, for acquiring a combination of the visit interval and the replacement interval for minimizing a predetermined cost for each consumable part of the plurality of apparatuses that are maintenance targets; maintenance plan creation means, on the basis of the minimized visit interval and replacement interval acquired by the interval information acquiring means and the counter value acquired by the counter value acquiring means, for identifying the apparatus that is a maintenance target to be visited next, the timing of next visit, and a consumable part to be replaced at the timing; and display means for displaying information identified by the maintenance plan creation means on a terminal.

Furthermore, the maintenance planning method of an embodiment of the present invention is comprised acquiring a counter value indicating use results of consumable parts of a plurality of apparatuses that are maintenance targets; acquiring a combination of the visit interval and the replacement interval for minimizing a predetermined cost for each consumable part of the plurality of apparatuses that are maintenance targets among information related to a combination of a visit interval for specifying a time interval for visiting installation places of the plurality of apparatuses that are maintenance targets to perform a maintenance check operation for the plurality of apparatuses that are maintenance targets with a replacement interval which is specified to replace each consumable part and is associated with the visit interval; forming a maintenance plan for identifying an apparatus that is a maintenance target to be visited next, timing of next visit, and a consumable part to be replaced at the timing on the basis of information acquired by the interval information acquiring step and a counter value acquired by the counter value acquiring step; and displaying information identified by the maintenance plan step on a terminal.

### BRIEF DESCRIPTION OF THE DRAWINGS

FIG. 1 is an entire drawing of the system showing an embodiment relating to the present invention;

FIG. 2 is a block diagram showing the outline of the maintenance planning system relating to the present invention;

FIG. 3 is a drawing showing an example of the maintenance plan calculating unit relating to the present invention;

FIG. 4 is a drawing showing an example of the “consumable supply status” table relating to the present invention;

FIG. 5 is a drawing showing the relationship between the data format used by a maintenance planning system 1 relating to the present invention and each data table;

FIG. 6 is a drawing showing an example of the “maintenance history” table relating to the present invention;

FIG. 7 is a drawing showing an example of the status that the contents of the “machine” table relating to the present invention are changed;

FIG. 8 is a drawing showing an example of the status that the contents of the “machine” table relating to the present invention are changed;

FIG. 9 is a drawing showing an example of the status that the contents of the “consumable supply status” table relating to the present invention are changed;

FIG. 10 is a drawing showing the samples that the maintenance check strategy for the machines having the ID Nos. relating to the present invention of “100213”, “100214”, and “101501” is set;

FIG. 11 is a flow chart showing a rough procedure of the maintenance operation simulation relating to the present invention;

FIG. 12 is a drawing showing the results of the maintenance operation simulation relating to the present invention;

FIG. 13 is a flow chart showing the processing flow of the operation date indicating mode of the maintenance planning system relating to the present invention;

FIG. 14 is a drawing showing an example of the “counter history” table relating to the present invention; and

FIG. 15 is a drawing showing an example that in the field of “Operation Scheduled Date” on the calendar, a list of “machine, ID” and the detailed information of the machine are displayed on the terminal.

### DETAILED DESCRIPTION OF THE INVENTION

Hereinafter, the embodiments of the maintenance planning system relating to the present invention will be explained with reference to the accompanying drawings. Further, in the following explanation, the maintenance planning system is applied to a multi function peripheral (MFP), though the present invention is not limited to the MFP.

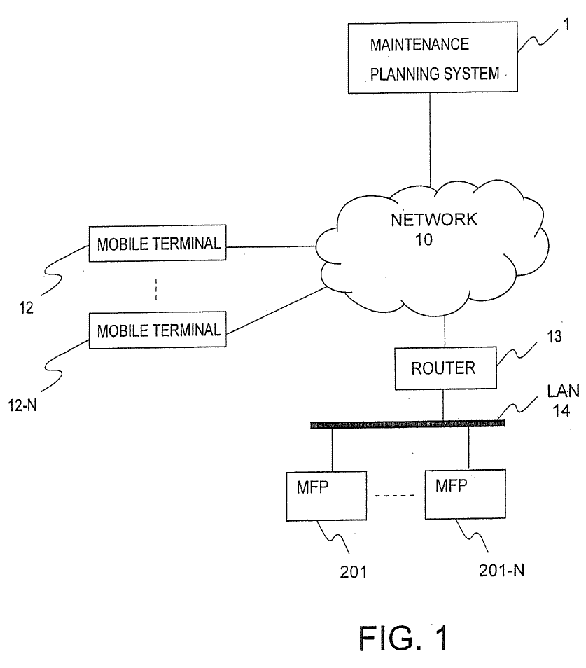

(First embodiment) FIG. 1 is a drawing showing the relationship of a communication system between the maintenance planning system relating to the embodiments of the present invention and a product that is maintenance target. The maintenance planning system 1 is connected to various terminals via a network 10. The various terminals, for example, may be considered to be a plurality of MFPs 201 to 201-N and a plurality of mobile terminals 12 to 12-N.

Namely, the maintenance planning system 1 is connected to the network 10 and acquires the information relating to the use status and maintenance history of the MFPs 201 to 201-N. On the basis of these information, the maintenance planning system 1 forms a maintenance plan and via the network 10, transmits the information of the maintenance plan formed to the MFPs 201 to 201-N and the mobile terminals 12 to 12-N possessed by a serviceman. The mobile terminals 12 to 12-N and MFPs 201 to 201-N receiving the maintenance plan information, according to the user's request, display the maintenance plan information from the maintenance planning system 1. In this embodiment, the case that the plurality of MFPs 201 to 201-N are installed in places where they are not separated from each other may be considered. In this case, a router 13 is installed between the network 10 and the MFPs 201 to 201-N and the plurality of MFPs 201 to 201-N are connected to each other by a LAN (local area network) 14.

The MFPs 201 to 201-N relating to this embodiment are not limited to the MFPs having a communication function. When the MFPs 201 to 201-N have no communication function, on the communication terminal possessed by the serviceman, the maintenance plan information relating to the MFPs 201 to 201-N which is transmitted from the maintenance planning system 1 can be displayed.

Further, to eliminate external unjust access, a fire wall may be installed between the maintenance planning system 1 and the network 10.

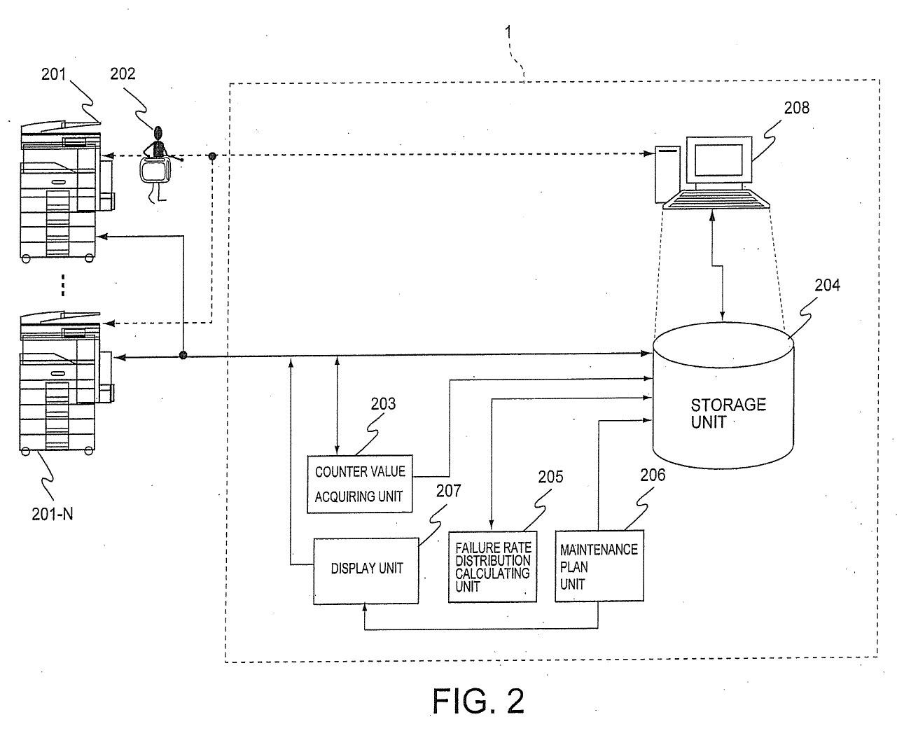

FIG. 2 is a system schematic view showing the constitution of the maintenance planning system 1 relating to this embodiment of the present invention. FIG. 2 shows an example that a maintenance plan of the MFPs 201 to 201-N installed by a user is generated by the maintenance planning system 1 and a serviceman 202 performs maintenance services according to the concerned maintenance plan.

The maintenance planning system 1 relating to this embodiment is structured so as to calculate the failure rate distribution of each consumable part on the basis of the past maintenance history data and on the basis of the calculated failure rate distribution, calculate a list of the visit time for the next maintenance operation and consumable parts to be replaced at that time.

The maintenance planning system 1 aforementioned performs the maintenance plan relating to consumable parts of an apparatus that is a maintenance target and is composed of a counter value acquiring unit 203, a storage unit 204, a failure rate distribution calculating unit 205, a maintenance plan unit 206, and a display unit 207.

The failure rate distribution calculating unit 205, on the basis of the maintenance history data as history information relating to the maintenance operation performed for the apparatus that is a maintenance target, calculates the failure rate distribution of each consumable part. Here, the history information relating to the maintenance operation performed for the apparatus that is a maintenance target, for example, is input by the communication terminal carried by the serviceman 202 performing the maintenance operation, thereby is stored in the storage unit 204 in a service center terminal 208. Or, it is stored in the storage unit 204 via the network 10.

The maintenance plan unit 206 has a function for calculating the timing of the next visit for maintenance check and a consumable part to be replaced at the time of operation (that is, at the time of the maintenance check operation) for each apparatus that is a maintenance target.

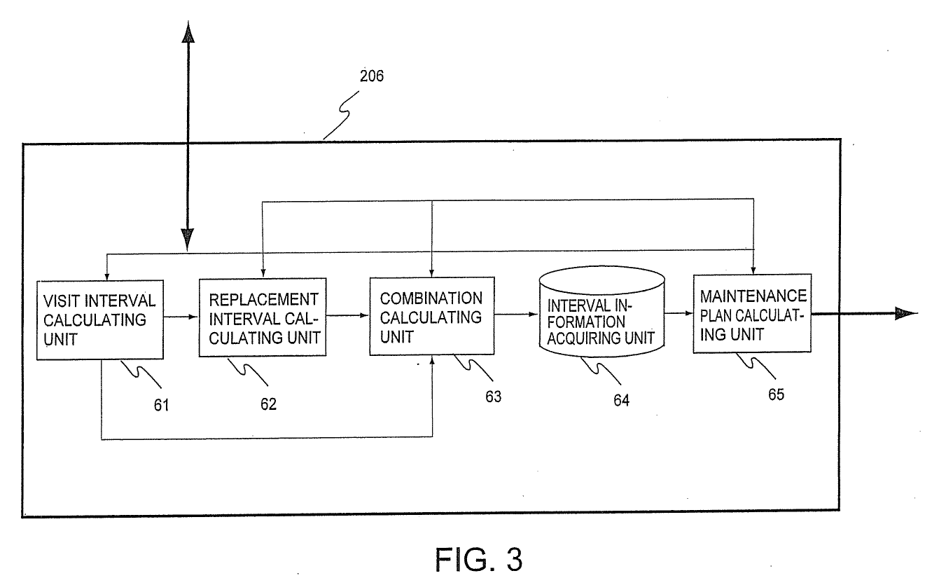

FIG. 3 is a block diagram showing the constitution of the maintenance plan unit 206. The maintenance plan unit 206 is composed of a visit interval calculating unit 61, a replacement interval calculating unit 62, a combination calculating unit 63, an interval information acquiring unit 64, and a maintenance plan calculating unit 65.

The visit interval calculating unit 61, on the basis of the failure probability distribution of each consumable part calculated by the failure rate distribution calculating unit 205, calculates the “visit interval” for specifying the time interval for visiting the installation place of the apparatus that is a maintenance target for the maintenance check operation of each consumable part at random for each consumable part. Further, the replacement interval calculating unit 62, on the basis of the failure probability distribution of each consumable part, calculates the “replacement interval” for specifying the time interval for replacing each consumable part at random for each consumable part. Further, as a “consumable part” here, for example, a photosensitive drum, a charger wire, a fixing roller, and a transfer belt may be cited and the present invention includes at least one of them. Further, this embodiment includes, as a “consumable part”, a cartridge in which a plurality of consumable parts having respectively different functions are united integrally.

The visit interval calculating unit 61 and replacement interval calculating unit 62, on the basis of the failure probability distribution of each consumable part, calculate a value in the neighborhood of the interval where the failure probability is predicted to be a predetermined probability or higher. Further, the replacement interval calculated for each consumable part by the replacement interval calculating unit 62 is set to a shorter interval than the visit interval calculated by the visit interval calculating unit 61.

The combination calculating unit 63, on the basis of the visit interval and replacement interval calculated by the visit interval calculating unit 61 and replacement interval calculating unit 62, perform a search processing using the Monte Carlo method or a genetic algorithm. By the search processing, among the combinations of the visit interval for visiting to perform the maintenance operation and a consumable part to be replaced at the time of the maintenance operation, the combination calculating unit 63 calculates the combination of the “visit interval and replacement interval” for minimizing a predetermined cost. Here, the “predetermined cost” is the total of the personal expenses charged for the maintenance operation by the serviceman, the cost of materials of the consumable parts, and the amount of loss of the user caused by unavailability of the apparatus that is a maintenance target.

The interval information acquiring unit 64 acquires the information relating to the combinations of the “visit interval and replacement interval” calculated by the combination calculating unit 63.

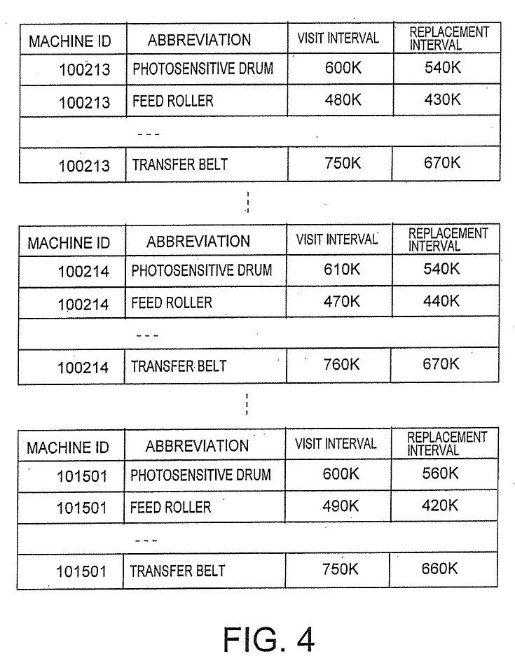

The interval information acquiring unit 64, as shown in FIG. 4, has a storage unit for storing the information on the combinations of the “visit interval” and “replacement interval” for minimizing the predetermine cost as a data base for each apparatus that is a maintenance target.

The maintenance plan calculating unit 65, on the basis of the information relating to the combination acquired by the interval information acquiring unit 64 and the counter values of the MFPs 201 to 201-N, prepares a list of the visit timing for performing the next operation and consumable parts to be replaced at the visit timing. The maintenance plan calculating unit 65 displays the list on the operation input unit of the service center terminal 208 via the display unit 207 or on the mobile communication terminals 12 to 12-N carried by the serviceman 202.

Again in FIG. 2, the counter value acquiring unit 203 acquires the “counter value” indicating the use results of the consumable parts from the apparatus that is a maintenance target. The counter value means the “use result values” effective in confirming the deterioration degree of each consumable part mounted in the MFPs 201 to 201-N. The counter values acquired by the counter value acquiring unit 203 are stored in the storage unit 204.

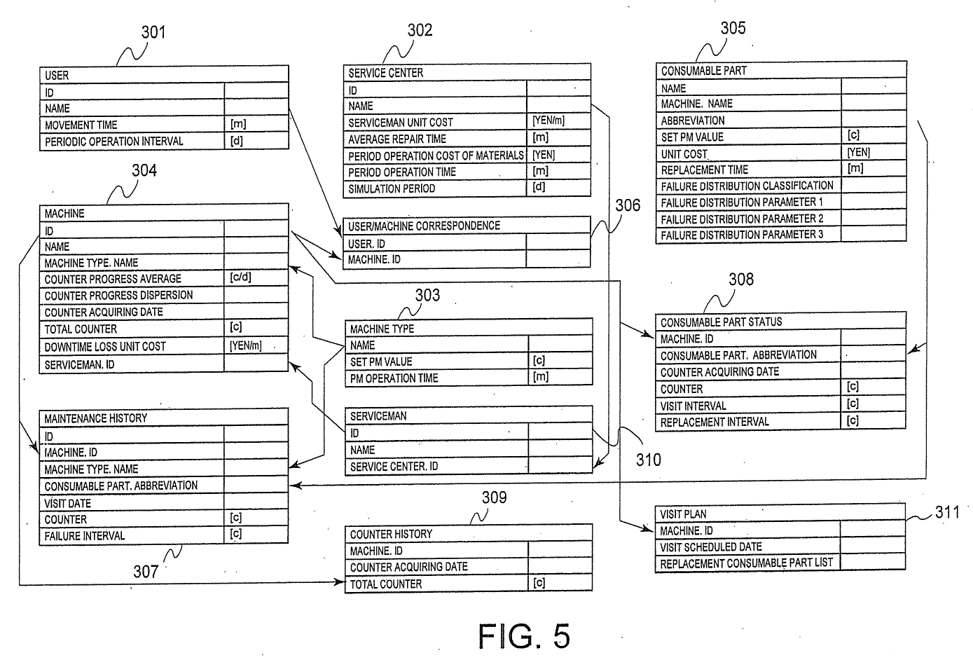

FIG. 5 is a drawing showing the relationship between the data format used by the maintenance planning system 1 relating to this embodiment and each data table. Each data table is stored in the storage unit 204.

As shown in FIG. 5, the maintenance planning system 1 includes of a “user” table 301, a “service center” table 302, a “machine type” table 303, a “machine” table 304, a “consumable supply” table 305, a “user/machine correspondence” table 306, a “maintenance history” table 307, a “consumable supply status” table 308, a “counter history” table 309, a “serviceman” table 310, and a “visit plan” table 311.

In the “user” table 301, the constant for each user is set. In the “service center” table 302, the constant for the service center terminal 208 is set. In the “machine type” table 303, the constant for the machine type is set. In the “machine” table 304, the constant for each machine and the variable calculated from the use status are set. In the “consumable supply” table 305, the constant for a consumable part and the failure rate variable calculated from market data are set.

In the “user/machine correspondence” table 306, the correspondence of the machine possessed by a user to the user is shown. In the “maintenance history” table 307, the maintenance operation history of the serviceman is recorded. In the “consumable supply status” table 308, the status of each consumable part is set. In the “counter history” table 309, the counter history of each machine is recorded. In the “serviceman” table 310, the constant for the serviceman 202 is set. In the “visit plan” table 311, a list of the visit scheduled date to each machine and consumable parts to be replaced is set.

Further, each arrow shown in the drawing indicates that the attribute at the arrow source is set in the attribute of the arrow destination. In the attribute set in this way, before “.” of the attribute of the arrow destination, the table name of the reference source is indicated and after “.”, the attribute name of the reference source is indicated. For example, “machine. ID” of the “maintenance history” table 307 indicates “ID” of the “machine” table 304.

The serviceman 202, from the operation records summarized as a report of the maintenance services, according to the format of the maintenance history table, performs the input operation from the service center terminal 208 or the mobile communication terminals 12 to 12-N. By doing this, the tables of the storage unit 204 are updated.

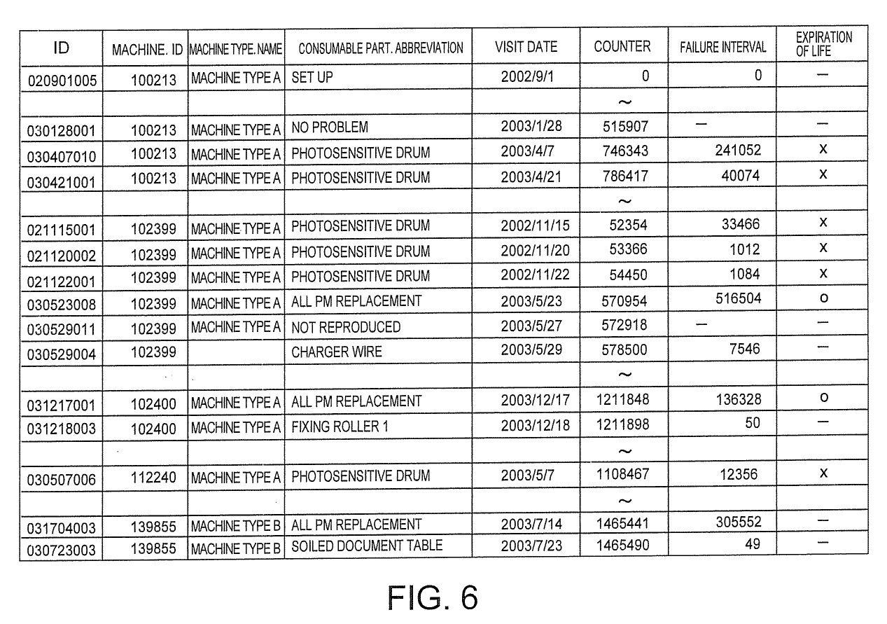

Further, the MFPs 201 to 201-N are connected communicably to the service center terminal 208 via the Internet or public telephone line and when it becomes the periodic communication time (for example, 10 o'clock everyday) set in the MFPs 201 to 201-N, the MFPs 201 to 201-N communicate with the service center terminal 208. The MFPs 201 to 201-N, at the time of the concerned communication, transmit the ID numbers of the MFPs 201 to 201-N, the present date and time, and the present total counter value to the service center terminal 208. The service center terminal 208 reflects the information received from the MFPs 201 to 201-N on the “counter history” table 309 stored in the storage unit 204. Thereafter, the MFPs 201 to 201-N confirm the communication status and additional information and finishes the communication with the service center terminal 208. FIG. 6 is a drawing showing an example of the “maintenance history” table 307 the contents of which are updated as mentioned above.

Further, as the “total counter value”, the A4 copy print is assumed as 1, and the A3 copy print is assumed as 2, and the “counter” indicating how many copies of the A4 size are output indicates the similar value, and here, the “counter” of the “maintenance history” table 307 which is input by the serviceman 202 indicates the similar value.

The failure rate distribution calculating unit 205 executes fitting F to the Weibull distribution (m: shape parameter, \acute{η}: scale parameter) widely used for the failure rate distribution analysis from the “maintenance history” table 307.

F(t)=1−exp {−(t/\acute{η})^{m}}

Here, the “photosensitive drum” which is a consumable part of the machine type A will be explained as an example. The failure rate distribution calculating unit 205, to obtain the failure distribution of the photosensitive drum, from the “maintenance history” table 307 read from the storage unit 204, extracts the data relating to the photosensitive drum and calculates the failure interval. For example, as shown in FIG. 6, the failure rate distribution calculating unit 205, from the maintenance history table 307, extracts all tuples that “machine type. name” is “machine type A” and “consumable part, abbreviation” is “photosensitive drum” and all tuples that “machine type. name” is “machine type A” and “consumable part. abbreviation” is “PM all replacement” and calculates the failure interval from the difference from the counter value at the time of the preceding replacement. PM is an abbreviation of preventive maintenance.

Further, “X” in the column of “Life Arrival” at the right end of the “maintenance history” table 307 shown in FIG. 6 indicates the data when the photosensitive drum fails before arrival at the PM and “O” indicates the replaced data when it arrives at the PM free of failure. Data including the data (O) replaced like this before failure is referred to as “censored data” and as an analysis method for such data, the cumulative hazard method is known. On the basis of the failure interval of each tuple extracted by the cumulative hazard method, the shape parameter m of the Weibull distribution and the scale parameter \acute{η} are inferred and the failure distribution related variable of the “consumable supply” table 305 is updated.

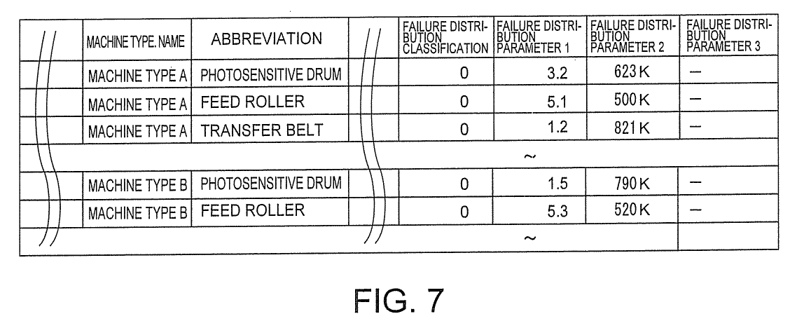

Namely, the cumulative hazard method extracts the tuple that “machine type. name” and “abbreviation” of the “consumable supply” table 305 coincide with “machine type A” and “photosensitive drum” and substitutes the shape parameter m for “failure distribution parameter 1” and the scale parameter \acute{η} for “failure distribution parameter 2”. In the “failure distribution classification”, a constant (0) equivalent to the Weibull distribution is set. The cumulative hazard method makes the calculation for each consumable part and updates the “consumable supply” table 305 of the storage unit 204. FIG. 7 is a drawing showing an example of the “consumable supply” table 305 in the state that it is updated as mentioned above.

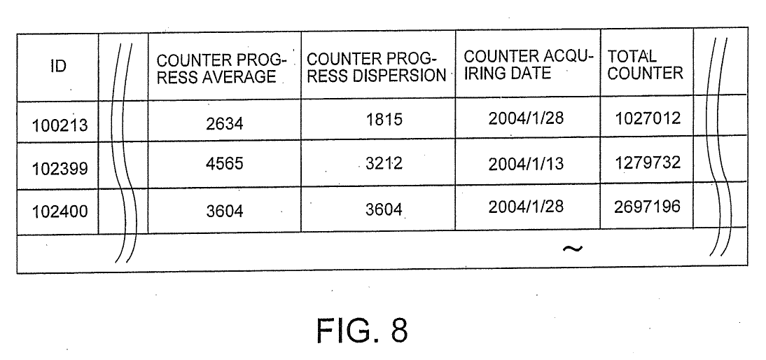

Further, the failure rate distribution calculating unit 205, on the basis of the “counter history” table 309 shown in FIG. 5, calculates the progress distribution of the number of copies per day for each apparatus that is a maintenance target. Namely, the failure rate distribution calculating unit 205 extracts the tuple having the same “machine. ID” from the “counter history” table 309, on the basis of the difference (the number of days) in the counter acquiring date and the counter variation (progress), calculates the mean value and dispersion of the counter progress, and updates the “counter progress average” and “counter progress dispersion” of the “machine” table 304. Similarly, for each machine, it updates the latest use status and the replacement date of each consumable part. FIG. 8 is a drawing showing an example of the “machine” table 304 in the state that the contents thereof are updated.

With respect to the use status, the “counter acquiring date” of the latest “counter history” table 309 from all the tuples extracted by “machine. ID” from the “counter history” table 309 and the “total counter” value at that time, as latest counter data, are set in the “counter acquiring date” and “total counter” of the “machine” table 304.

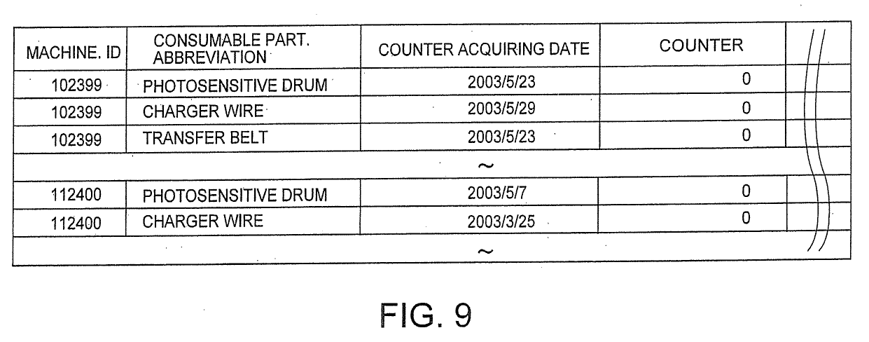

The “machine” table 304 shown in FIG. 8 is an example of the data after updating. With respect to the replacement date for each consumable part, from all the tuples extracted by “machine. ID” from the “maintenance history” table 307, the tuple that “consumable part. abbreviation” is the concerned consumable part or “PM all replacement” or “setup” is extracted and the latest “operation date” is set in the “counter acquiring date” of the “consumable supply status” table 308. In the “counter” of the “consumable supply status” table 308, “O” is set. FIG. 9 is a drawing showing an example of the data of the “consumable supply status” table 308 the contents of which are updated as mentioned above. Further, the “operation date” means a day of visiting the installation place of the apparatus that is a maintenance target for the maintenance check operation.

Next, the operation of the maintenance plan unit 206 will be explained. The maintenance plan unit 206 can execute the “strategy creation mode” and “operation date indicating mode”. The “strategy creation mode” is executed when a fixed amount of maintenance history data is additionally entered into the storage unit 204 or at the periodic timing once per month and the “operation date indicating mode” is executed everyday.

The “strategy creation mode” will be explained below. In this embodiment, it optimizes simultaneously the maintenance check plans of a plurality of apparatuses that are maintenance targets (here, the MFPs 201 to 201-N). For example, execution of the maintenance check plans for a plurality of MFPs 201 to 201-N used by the same user or a plurality of MFPs 201 to 201-N installed in the same building, factory, or institution may be considered.

The maintenance plan unit 206, to extract the information of a plurality of machines installed in the neighborhood, refers to the “user/machine correspondence” table 306 shown in FIG. 5. It extracts all the tuples checked by “user. ID” of the “user/machine correspondence” table 306 and obtains a list of “machine. ID”. And, for each machine, it calculates and sets the “visit interval” and “replacement interval” for each consumable part. The serviceman 202 performs the maintenance operation on the basis of the “visit interval” and “replacement interval”. Namely, the serviceman 202, for the apparatus that is a maintenance target (here, the MFP 201), even if only one consumable part reaches the “visit interval”, performs the operation for the concerned apparatus. And, the serviceman 202 intends to replace all the consumable parts reaching the “replacement interval” at the time of visit.

Then, the calculation method for the “visit interval” and “replacement interval” will be explained in detail. The maintenance plan unit 206 executes the maintenance operation simulation for the period set in the “simulation period” of the “service center” table 302 shown in FIG. 5 and calculates the “visit interval” and “replacement interval” for minimizing the necessary cost as far as possible. As a calculating method, the Monte Carlo method or a discovery method such as the genetic algorithm is used. Namely, the maintenance plan unit 206 sets the “visit interval” and “replacement interval” at random, repeats the maintenance operation simulation, calculates the cost, and adopts the “visit interval” and “replacement interval” for minimizing the cost among them.

The longer the set value of the simulation period is, the better it will be, though in correspondence to it, the calculation time becomes longer, so that it is desirable to set a sufficient period of time for the mean failure time of the machine.

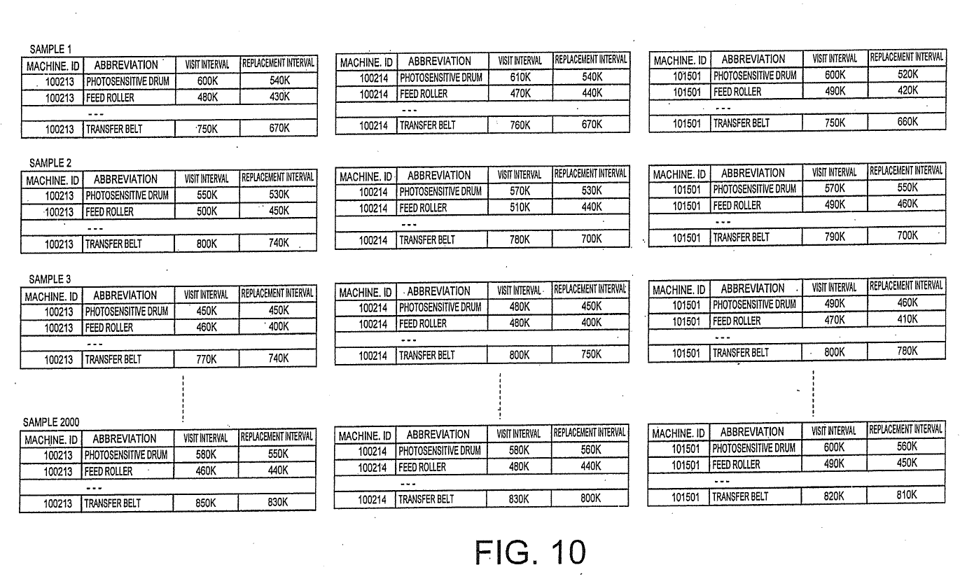

Concretely, an example that the maintenance check operation simulation is executed using the Monte Carlo method is shown in FIG. 10. FIG. 10 shows a sample that the “machine. ID” sets the maintenance check plan strategy (a combination of the visit interval and replacement interval for each consumable part) for the machines of “100213”, “100214”, and “101501” and it prepares at random 2000 maintenance check plan strategy samples.

Here, the preparation of a sample is generated basically at random, though to avoid preparation of a useless sample, it is desirable to generate it in the neighborhood of the visit interval and replacement interval which are expected empirically from the failure probability distribution of each consumable part. For the 2000 maintenance plan strategies, the maintenance operation simulation for each machine is executed and the sample for minimizing the cost is obtained for each machine.

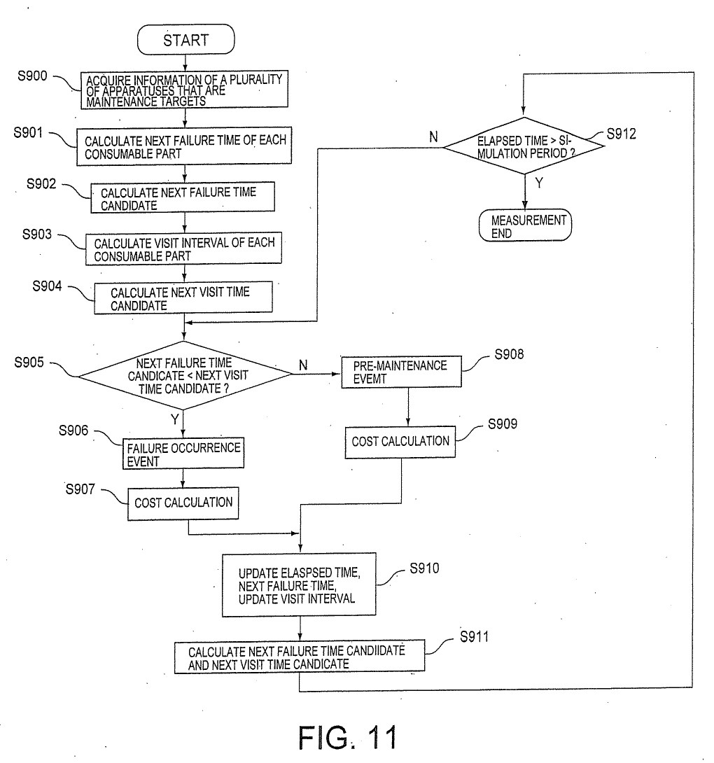

Next, the maintenance operation simulation for the maintenance plan strategy samples shown in FIG. 10 will be explained by referring to the flow chart shown in FIG. 11. FIG. 11 is a flow chart showing the procedure of the maintenance operation simulation.

The maintenance plan unit 206 refers to the “user/machine correspondence” table 306 and acquires the information of a plurality of apparatuses that are maintenance targets installed in the neighborhood (Step S900). Here, it is desirable to install the apparatuses that are maintenance targets in a place where the movement distance of the serviceman 202 may not be considered as cost. Therefore, it is necessary to set beforehand the range of execution of a maintenance target. In the following explanation, the IDs of a plurality of MFPs 201 to 201-N installed in the same building are “100213”, “100214”, and “101501”.

The maintenance plan unit 206, for the machine that “machine, ID” is “100213”, checks the “machine. name” of the “machine” table 304 shown in FIG. 5 with the “machine type. name” of the “consumable supply” table 305 and extracts all the tuples of the coinciding “consumable supply” table 305. And, on the basis of the failure probability indicated by “failure distribution classification”, “failure distribution parameter 1”, and “failure distribution parameter 2” of the “consumable supply” table 305, it generates random numbers and calculates the next failure estimation time candidate of each consumable part (Step S901). Similarly, for the machines that “machine. ID” is “100214” and “machine. ID” is “101501”, the maintenance plan unit 206 calculates the next failure estimation time candidate of each consumable part. And, it sets the shortest one among the next failure estimation time candidates calculated as a next failure estimation generation time candidate (Step S902).

On the other hand, the maintenance plan unit 206 checks “ID” of the “machine” table 304 with “machine. ID” of the “consumable supply status” table 308, extracts all the tuples of the “consumable supply status” table 308 having the coinciding “machine. ID”, and calculates the next visit scheduled date of the serviceman 202.

Namely, for the respective consumable parts extracted, the maintenance plan unit 206 refers to the “visit interval” set in the “consumable supply status” table 308 (Step S903). And, it sets the value obtained by dividing the shortest visit interval by the “counter progress average” of the “machine” table 304 shown in FIG. 5 as a next visit time candidate (Step S904).

The maintenance plan unit 206 compares the next failure time candidate calculated on the basis of the failure probability with the next visit time candidate obtained from the “consumable supply status” table 308 shown in FIG. 5 and decides the event.

When the next failure estimation generation time candidate is shorter than the next visit time candidate (Y at Step S905), there is a fear that a failure may occur before the maintenance check, so that as a failure occurrence event, the next failure estimation generation time candidate is assumed as an elapsed time (Step S906). Further, the maintenance plan unit 206 decides the consumable part to be replaced and calculates the charged cost (Step S907). For all the consumable parts other than the consumable part in which a failure occurs, it refers to the “replacement interval” of the “consumable supply status” table which is preset and sets the one shorter than the next failure estimation generation time candidate as a replacement consumable part and the cost is the sum indicated below.

Cost=personal expenses+cost of materials+downtime loss

where:

personal expenses=“user. movement time”+“consumable part. replacement time” of Σreplacement consumable part)×unit cost of serviceman,

cost of materials=“consumable part. unit cost” of Σreplacement consumable part, and

downtime loss=“user. movement time”×“machine. unit cost of downtime loss”.

Further, the “user. movement time” indicates the movement time from the service center terminal 208 to the user's location.

On the other hand, when the next failure estimation generation time candidate is longer than the next visit time candidate (N at Step S905), there is a little fear that a failure may occur before the operation, so that as a pre-maintenance event, the next visit time candidate is assumed as an elapsed time (Step S908). Similarly, the maintenance plan unit 206 decides the consumable part to be replaced and calculates the charged cost (Step S909). For all the consumable parts other than the consumable part for which the premaintenance is executed (reaching the visit interval), it refers to the “replacement interval” of the “consumable supply status” table 308 which is preset and sets the one shorter than the next visit time candidate as a replacement consumable part. The cost is the sum indicated below.

Personal expenses=“user. movement time”+“consumable part. replacement time” of Σreplacement consumable part)×unit cost of serviceman,

cost of materials=“consumable part. unit cost” of Σreplacement consumable part, and

downtime loss=0.

With respect to the concept on the downtime, for the operation time itself of the service man, the downtime is zero. Here, at the time of an unexpected failure, the time until the serviceman rushes to the scene is considered as downtime.

For the replaced consumable part, the maintenance plan unit 206 calculates newly the next replacement time and for the consumable parts not replaced, it updates the next failure time candidate by the value obtained by subtracting the elapsed time from the next failure time candidate calculated, subtracts the value obtained by multiplying the elapsed time by the “counter progress average” of the “machine” table 304 from the visit time, and updates the visit interval (Step S910). Hereinafter, similarly, the maintenance plan unit 206 decides the next failure time candidate and next visit time candidate (Step S911) and repeats decision of the event, decision of the replacement consumable part, and calculation of the cost until the period expires during the simulation period (Step S912).

Assuming the simulation as one set, the maintenance plan unit 206 simulates the maintenance plan strategy samples of all the apparatuses that are maintenance targets shown in FIG. 10, adopts the maintenance plan strategy sample of the lowest cost calculated as an optimum strategy and sets the optimum strategy to the “consumable part status. visit interval” and “consumable part status. replacement interval”.

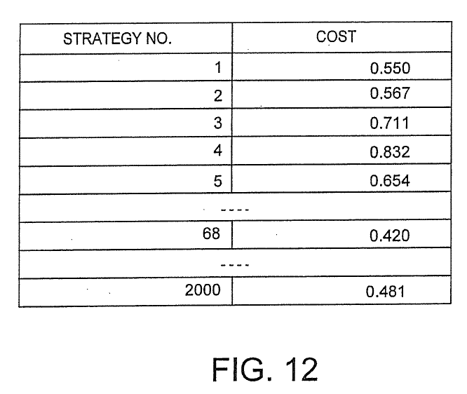

FIG. 12 is a drawing showing the simulation results of the respective samples. In this example, the 68th sample shows the minimum average cost per count for each unit and is adopted as an optimum strategy. And, the “visit interval” and “replacement interval” of the optimum strategy are set in the “visit interval” and “replacement interval” of the “consumable supply status” table 308 for each consumable part.

Further, the MFP 201, as additional information at the time of periodic communication, downloads the “visit interval” and “replacement interval” of the “consumable supply status” table 308 and can set its own memory. In this case, it can be considered that the MFP 201 displays properly the “visit interval” and “replacement interval” which are an optimum strategy to the user on its own display panel.

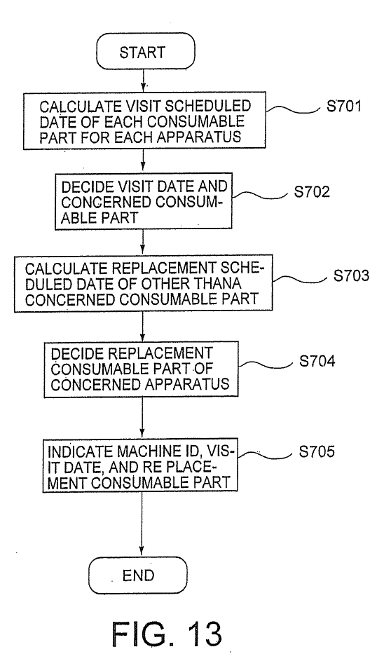

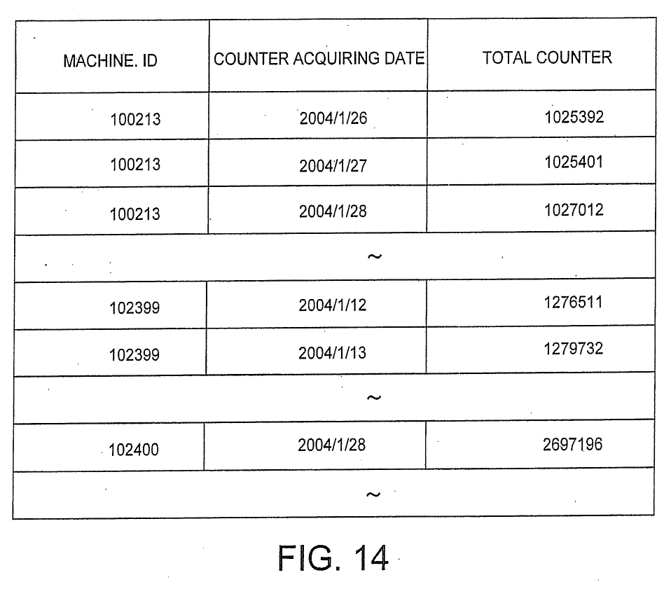

Then, the “visit date indicating mode” will be explained. FIG. 13 is a flow chart showing the processing flow of the visit date indicating mode of the maintenance planning system 1 and FIG. 14 is a drawing showing an example of the “counter history” table 307.

In the “visit date indicating mode”, the case that the serviceman 202 confirms daily the next visit date (the timing of maintenance-checking the apparatus) is supposed.

By the “strategy creation mode” aforementioned, the “visit interval” and “replacement interval” which are desirable are preset and the serviceman 202 inputs the “machine. ID” of the machine in charge from the service center terminal 208, thereby confirms the next visit date.

The maintenance plan unit 206 checks “ID” of the “machine” table 304 shown in FIG. 5 with “machine. ID” of the “consumable supply status” table 308. And, it extracts all the “consumable supply status” tables 308 having the “machine. ID” coinciding with the “ID” and refers to the “counter acquiring date”, “counter”, “visit interval”, and “replacement interval”. Further, it refers to the “counter progress average” from the “machine” table 304.

The maintenance plan unit 206 performs the following calculations and calculates the next visit scheduled date for each consumable part (Step S701).

Visit scheduled date=counter acquired date+(visit interval−counter)/counter progress average

The maintenance plan unit 206 decides the shortest one among the visit scheduled dates of the respective consumable parts as a visit date (Step S702) and for the consumable parts other than the consumable part giving the shortest visit scheduled date, it performs the following calculations and calculates the replacement scheduled date (Step S703).

Replacement scheduled date=counter acquired date+(replacement interval−counter)/counter progress average

The maintenance plan unit 206 decides the consumable part having the replacement scheduled date shorter than the visit scheduled date as a replacement consumable part (Step S704). The display unit 207 indicates the date of performing the decided operation and the consumable part to be replaced to the serviceman 202 from the output device such as the mobile communication terminal 12 (Step S705).

Further, in addition to the aforementioned process, it is possible to use the “counter progress dispersion” of the “machine” table 304 shown in FIG. 5, express the “counter progress dispersion” as a section, and infer the visit date by a period.

In the embodiment aforementioned, for a plurality of MFPs installed in a place separated not so much, the maintenance plan can be optimized simultaneously. Further, in addition to it, when the movement time of the serviceman 202 between other users is not so much, even if the same user uses a plurality of MFPs 201 to 201-N, it is possible to prepare the IDs in the “user” table 301 for each group of the summarized MFPs 201 to 201-N at the same place and perform calculations for each group.

(Second embodiment) This embodiment, in the “visit date indicating mode”, periodically executes calculations for all a plurality of machines entered beforehand.

The maintenance plan unit 206 has a schedule function executed periodically (for example, at 6 o'clock everyday), executes the “visit date indicating mode” of all users entered in the “user” table 301 shown in FIG. 5, and updates the “visit plan” table 311 shown in FIG. 5. The serviceman 202, when he comes to office, using the mobile communication terminals 12 to 12-N from the operation output unit of the service center terminal 208 or outside the company, accesses the maintenance planning system 1, inputs his ID, and asks the maintenance schedule. The maintenance plan unit 206 checks the input ID with the “serviceman. ID” of the “machine” table 304 and extracts all the tuples of the coinciding “machine” table 304. Furthermore, it checks the “IDs” of all the extracted tuples with the “machine. ID” of the “visit plan” table 311 shown in FIG. 5 and extracts all the tuples of the “visit plan” table 311 having the coincided IDs. From all the extracted tuples, the maintenance plan unit 206 searches the tuple having a nearest “visit scheduled date”, checks the concerned “machine. ID” with the “user/machine correspondence” table 306, and identifies the “user. ID” and “user. name” of the visit destination.

When there are a plurality of machines of the nearest visit scheduled date, the maintenance plan unit 206 selects one of them. It checks again the identified “user. ID” with the “user/machine correspondence” table 306, extracts all the tuples having the coincided IDs, and prepares a list of the concerned “machine. ID”. Furthermore, the maintenance plan unit 206 checks the prepared “machine. ID” list with the “machine. ID” of the “visit plan” table 311 shown in FIG. 5, extracts all the tuples of the “operation plan” table 311 having the coincided IDs, prepares a list of “machine. ID”, “visit scheduled date”, and “replacement consumable part list”, and displays them on the operation output unit of the service center terminal 208 together with the “user. ID” and “user. name”. Or, it displays them on the mobile communication terminals 12 to 12-N via the display unit 207.

When a request of a list of future maintenance target users is input from the serviceman 202 via the service center terminal 208 or the mobile communication terminals 12 to 12-N, the maintenance plan unit 206 similarly searches the “machine” table 304 and “user/machine correspondence” table 306 shown in FIG. 5 in this order from the ID of the serviceman 202 and prepares a list of “user. ID” and “user. name”. Further, it prepares again a list of “machine. ID” for each “user. ID” from the “user/machine correspondence” table 306, extracts all the associated tuples in the “visit plan” table 311, and displays a list of “user. name” which is a maintenance target on the terminal in the order of “visit scheduled date”.

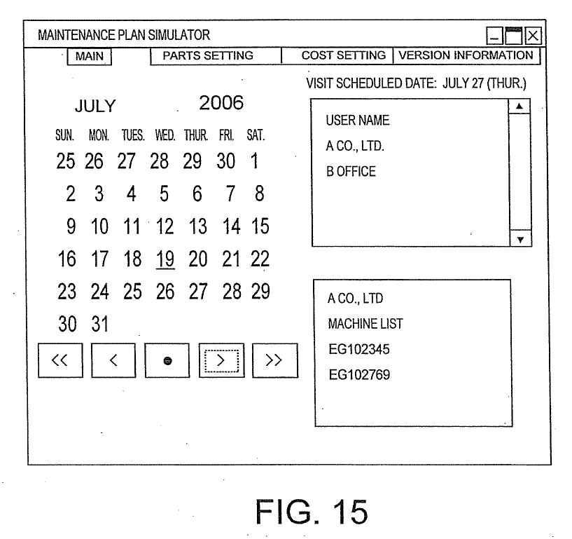

When a request of a list of future operation scheduled dates is input from the serviceman 202 via the service center terminal 208 or the mobile communication terminals 12 to 12-N, the maintenance plan unit 206 similarly searches the “machine” table 304 and “user/machine correspondence” table 306 in this order from the ID of the serviceman 202 and prepares a list of “user. ID” and “user. name”. Further, it prepares again a list of “machine. ID” for each “user. ID” from the “user/machine correspondence” table 306, extracts all the associated tuples in the “visit plan” table 311, displays the “visit scheduled date”, for example, on a calendar as displayed in FIG. 15, and displays a list of “user. name” of the “visit scheduled date” scheduled nearest and the detailed information of one user among them (a list of “user. name” and “machine. ID” associated from the “user, ID”) on the service center terminal 208. According to the information of “visit scheduled date” and “user. ID” which are input via the user interface of the service center terminal 208 (for example, the calendar date on the screen and click of “user. name”), the maintenance plan unit 206 changes the list of “user. name” and the display contents of the detailed information. Further, in the table of the list of maintenance target users or the list of visit scheduled dates, the maintenance plan unit 206, according to the information of selection of “user. ID” (for example, double-click of “user. name” on the screen) which is input via the user interface of the service center terminal 208, displays detailed information.

In a small service center, data may be displayed for each service center instead of each serviceman. In this case, if the ID of the service center is input, the “serviceman. ID” list is extracted from the “serviceman” table 310, and similarly, using the “machine” table 304, “user/machine correspondence” table 306, “user” table 301, and “visit plan” table 311, the corresponding information can be obtained.

In the two embodiments aforementioned, the case that the function for executing the invention is stored beforehand in the apparatus is used for the explanation, though the invention is not limited to it and the similar function may be down-loaded from the network into the apparatus or a recording medium in which the similar function is stored may be installed in the apparatus. As a recording medium, any recording medium which can store a program and can be read by the apparatus such as a CD-ROM is acceptable and the form thereof is no particular object. Further, the function obtained like this by previous installation or downloading may be realized in cooperation with the operating system (OS) in the apparatus.

As mentioned above, according to this embodiment, even when there are a plurality of apparatus that are maintenance targets installed, the two judgment standards of “visit interval” and “replacement interval” are set in each consumable part, thus the serviceman can confirm “when to visit” or “which consumable part to replace”. Further, desirable visit interval and replacement interval (strategy) are calculated beforehand using the “strategy creation mode” and generally, the next visit date is calculated on the basis of the decided strategy using the “visit date indicating mode”, so that the cost charged for calculation can be reduced. Further, the use status of the apparatus that is a maintenance target can be collected in real time via the network, so that the estimation precision of the day visiting the apparatus is improved greatly. Further, whether the replacement of a consumable part is due to the expiration of the life or not can be recorded, so that the failure probability distribution can be inferred precisely.

Further, for the serviceman 202, the list of the visit scheduled date order of the machine which is a target for each serviceman or service center and the schedule on the calendar can be confirmed, so that confirmation of the short-term service quantity and schedule adjustment can be executed.

Furthermore, for the MFPs installed in the same place for each user, including not only the status of one MFP but also the status of the other MFPs, an optimum maintenance plan can be formed.

The present invention is explained in detail using the specific embodiments, though without deviated from the spirit and scope of the present invention, various modifications and improvement are obvious for those who are skilled in the art in the field of the present invention. As described above in detail, according to the present invention, a technique can be provided that enables reduction in cost related to maintenance services and that also enables reduction in downtime of a product.

What is claimed is:

1. A maintenance planning system comprising:
a counter value acquiring unit to acquire a counter value indicating use results of consumable parts of a plurality of apparatuses that are maintenance targets;
an interval information acquiring unit, among information related to a combination of a visit interval to specify a time interval to visit installation places of the plurality of apparatuses that are maintenance targets to perform a maintenance check operation for the plurality of apparatuses that are maintenance targets with a replacement interval specified to replace each consumable part and associated with the visit interval, to acquire a combination of the visit interval and the replacement interval for minimizing a predetermined cost for each consumable part of the plurality of apparatuses that are maintenance targets;
a maintenance plan creation unit, on the basis of the minimized visit interval and replacement interval acquired by the interval information acquiring unit and the counter value acquired by the counter value acquiring unit, to identify the apparatus that is a maintenance target to be visited next, timing of next visit, and a consumable part to be replaced at the timing; and
a display unit to display information identified by the maintenance plan creation unit on a terminal.

2. The system according to claim 1, wherein the interval information acquiring unit includes:
a visit interval calculating unit, on the basis of a failure rate distribution of each consumable part, to calculate the visit interval for each consumable part;
a replacement interval calculating unit, on the basis of the failure rate distribution of each consumable part calculated by the visit interval calculating unit, to calculate the replacement interval for each consumable part; and
a combination calculating unit, on the basis of the visit interval calculated by the visit interval calculating unit and the replacement interval calculated by the replacement interval calculating unit, to calculate information relating to a combination of the time interval of next visit and a consumable part to be replaced at the time of the visit for each of the plurality of apparatuses that are maintenance targets.

3. The system according to claim 1, wherein the display unit displays the timing of the next visit in the descending order of timing of the next visit, the number of the apparatus that is a maintenance target to be visited next at the timing, and the consumable part to be replaced next at the timing on the terminal.

4. The system according to claim 2, wherein the visit interval calculating unit calculates the visit interval at random and the replacement interval calculating unit calculates the replacement interval at random.

5. The system according to claim 2, wherein the replacement interval of each consumable part calculated by the replacement interval calculating unit is set at a shorter interval than the visit interval calculated by the visit interval calculating unit.

6. The system according to claim 1, wherein the predetermined cost is a total of personal expenses charged for a maintenance operation by a serviceman, cost of materials of the consumable parts, and an amount of loss of a user caused by unavailability of the apparatus that is a maintenance target.

7. The system according to claim 1, wherein the consumable parts include at least one of a photosensitive drum, a charger wire, a fixing roller and a transfer belt.

8. The system according to claim 1, wherein the consumable parts include a cartridge in which a plurality of consumable parts having respectively different functions are united integrally.

9. A maintenance planning system comprising:
counter value acquiring means for acquiring a counter value indicating use results of consumable parts of a plurality of apparatuses that are maintenance targets;
interval information acquiring means, among information related to a combination of a visit interval for specifying a time interval for visiting installation places of the plurality of apparatuses that are maintenance targets to perform a maintenance check operation for the plurality of apparatuses that are maintenance targets with a replacement interval which is specified to replace each consumable part and is associated with the visit interval, for acquiring a combination of the visit interval and the replacement interval for minimizing a predetermined cost for each consumable part of the plurality of apparatuses that are maintenance targets;
maintenance plan creation means, on the basis of the minimized visit interval and replacement interval acquired by the interval information acquiring means and the counter value acquired by the counter value acquiring means, for identifying the apparatus that is a maintenance target to be visited next, the timing of next visit, and a consumable part to be replaced at the timing; and
display means for displaying information identified by the maintenance plan creation means on a terminal.

10. The system according to claim 9, wherein the interval information acquiring means includes:
visit interval calculating means, on the basis of a failure rate distribution of each consumable part, for calculating the visit interval for each consumable part;
replacement interval calculating means, on the basis of the failure rate distribution of each consumable part calculated by the visit interval calculating means, for calculating the replacement interval for each consumable part; and
combination calculating means, on the basis of the visit interval calculated by the visit interval calculating means and the replacement interval calculated by the replacement interval calculating means, for calculating information relating to a combination of the time interval of next visit and a consumable part to be replaced at the time of the visit for each of the plurality of apparatuses that are maintenance targets.

11. The system according to claim 9, wherein the display means displays the timing of the next visit in the descending order of timing of the next visit, the number of the apparatus that is a maintenance target to be visited next at the timing, and the consumable part to be replaced next at the timing on the terminal.

12. The system according to claim 10, wherein the visit interval calculating means calculates the visit interval at random and the replacement interval calculating means calculates the replacement interval at random.

13. The system according to claim 10, wherein the replacement interval of each consumable part calculated by the replacement interval calculating means is set at a shorter interval than the visit interval calculated by the visit interval calculating means.

14. The system according to claim 9, wherein the predetermined cost is a total of personal expenses charged for a maintenance operation by a serviceman, cost of materials of the consumable parts, and an amount of loss of a user caused by unavailability of the apparatus that is a maintenance target.

15. The system according to claim 9, wherein the consumable parts include at least one of a photosensitive drum, a charger wire, a fixing roller and a transfer belt.

16. The system according to claim 9, wherein the consumable parts include a cartridge in which a plurality of consumable parts having respectively different functions are united integrally.

17. A maintenance planning method comprising:
acquiring a counter value indicating use results of consumable parts of a plurality of apparatuses that are maintenance targets;
acquiring a combination of the visit interval and the replacement interval for minimizing a predetermined cost for each consumable part of the plurality of apparatuses that are maintenance targets among information related to a combination of a visit interval for specifying a time interval for visiting installation places of the plurality of apparatuses that are maintenance targets to perform a maintenance check operation for the plurality of apparatuses that are maintenance targets with a replacement interval which is specified to replace each consumable part and is associated with the visit interval;
forming a maintenance plan for identifying an apparatus that is a maintenance target to be visited next, timing of next visit, and a consumable part to be replaced at the timing on the basis of information acquired by the interval information acquiring step and a counter value acquired by the counter value acquiring step; and
displaying information identified by the maintenance plan step on a terminal.

18. The method according to claim 17, wherein the acquiring the combination of the visit interval and the replacement interval for minimizing the predetermined cost includes:
calculating the visit interval for each consumable part on the basis of a failure rate distribution of each consumable part;
calculating the replacement interval for each consumable part on the basis of the failure rate distribution of each consumable part; and
calculating information relating to a combination of the time interval of next visit and a consumable part to be replaced at the time of the visit for each of the plurality of apparatuses that are maintenance targets on the basis of the visit interval calculated and the replacement interval calculated.

19. The method according to claim 18, wherein the displaying step displays the timing of the next visit in the descending order of timing of the next visit, the number of the apparatus that is a maintenance target to be visited next at the timing, and the consumable part to be replaced next at the timing on the terminal.

20. The method according to claim 18, wherein the visit interval calculating step calculates the visit interval at random and the replacement interval calculating step calculates the replacement interval at random.
